(19) United States
(12) Patent Application Publication
(10) Pub. No.: US 2007/0269676 A1
(43) Pub. Date: Nov. 22, 2007

(54) Diffusion barrier layer and method of making the same, and wear resistant article with the diffusion barrier layer and method of making the same

(76) Inventors: Kevin M. Singer, Louisville, KY (US); Donald W. Bucholz, Charlestown, IN (US)

Correspondence Address: KENNAMETAL INC., P.O. BOX 231, 1600 TECHNOLOGY WAY, LATROBE, PA, 15650, US

(21) Appl. No.: 11/438,025

(22) Filed: May 19, 2006

(51) Int. Cl. B32B 15/00; B05D 3/02; B05D 1/36

(52) U.S. Cl. 428/627; 428/679; 428/685; 427/402; 427/372.2

(57) ABSTRACT

A wear-resistant article that includes a substrate that presents a surface. The substrate has a bulk region and a surface region beginning at and extending inward from the surface toward the bulk region. There is a diffusion barrier layer on at least a portion of the surface of the substrate wherein the diffusion barrier layer is a nickel-based alloy. There is a wear-resistant cladding layer on the diffusion barrier layer wherein the wear-resistant layer contains boron. The surface region of the substrate contains no boron that has been diffused from the wear-resistant cladding layer.

### BACKGROUND OF THE INVENTION

The invention pertains to a wear-resistant article that has a substrate with a diffusion barrier layer on the substrate so as to block diffusion into the substrate of one or more components contained in a wear-resistant cladding layer separated from the substrate by the diffusion barrier layer, as well as a method of making the wear-resistant article. The invention also pertains to the diffusion barrier layer itself, as well as a method of making the diffusion barrier layer.

A typical wear-resistant article comprises a substrate that has a surface. A wear-resistant layer (or wear-resistant cladding layer) is on the surface of the substrate for the purpose of protecting the substrate from wear (e.g., abrasive wear).

One sample of such a wear-resistant article is a single screw extruder. In a typical arrangement for a single screw extruder, there is a wear-resistant cladding layer on the stainless steel screw of the extruder. A wear-resistant cladding layer is also on selected surfaces of the stainless steel extruder barrel. One sample of a wear-resistant cladding layer includes a matrix of tungsten carbide in metallic hardfacing alloy that has nickel, chromium, cobalt and boron (and optionally molybdenum) as its predominant components.

One method to apply the wear-resistant coating to the substrate is through the use of a flexible fibrous organic cloth (e.g., a flexible polytetrafluoroethylene (PTFE) cloth) that contains hard particles (e.g., tungsten carbide and the like). The flexible cloth covers the surface that is to have the wear-resistant layer. Another flexible fibrous organic cloth that contains particles of a metallic hardfacing alloy is positioned on top of the hard particle-containing flexible cloth. The cloths and the substrate are heated to a brazing temperature so as to melt the braze alloy. The result is that the tungsten carbide and the hardfacing alloy are metallurgically bonded to the surface of the substrate so as to form a wear-resistant cladding layer. This method is along the lines of the method disclosed in U.S. Pat. No. 3,743,556 to Breton et al.

In the case of the single screw extruder, the wear-resistant cladding layer covers the entire surface of the extruder screw, and a portion of the internal surface of the extruder barrel. The structure of the single screw extruder and the location of the wear-resistant cladding layer thereon, as well as a brief explanation of the process to apply the wear-resistant cladding layer, is set forth in Application Data Sheet PF-001 entitled “Wear Protection for a Single Screw Extruder” (©2003) available from Conforma Clad, Inc. that has a place of business at 501 Park East Blvd., New Albany, Ind. 47150, United States of America.

Another exemplary wear-resistant article is a twin-screw, co-rotating extruder barrel. Such an article is shown and described in Application Data Sheet PL-003 entitled “Twin-Screws, Co-Rotating Extruder Barrels” (©2003) available from Conforma Clad, Inc.

While the use of the flexible cloth to form a wear-resistant cladding layer on the surface of an article such as, a single screw extruder, has been successful, there remains at least one drawback with the resultant article. More specifically, heretofore, upon heating the flexible cloths to the brazing temperature, at least one of the elements (i.e., a diffusible element such as, for example, boron) that is in the hardfacing alloy diffuses into the stainless steel substrate and sensitizes the substrate or at least the surface region of the substrate (i.e., a portion of the substrate that begins at or near the surface of the substrate and extends inwardly therefrom). If at some time during the life of the wear-resistant article there is a breach in the wear-resistant cladding layer, such a sensitized stainless steel substrate (or a stainless steel substrate with a sensitized surface region) is then susceptible to intergranular corrosion when exposed to certain corrosive environments. The existence of intergranular corrosion will typically reduce the useful life of the wear-resistant article.

It is thus desirable to provide a wear-resistant article that has a substrate with a diffusion barrier layer on the substrate so as to, during the heat treatment to form the wear-resistant article, effectively block diffusion into the substrate of one or more components (i.e., diffusible elements) contained in the hardfacing alloy component of the wear-resistant cladding layer so that the substrate is not sensitized due to the penetration of such diffusible elements, as well as a method of making the wear-resistant article. The diffusion barrier layer separates the substrate from the wear-resistant cladding layer.

It is also desirable to provide a diffusion barrier on the surface of the substrate of a wear-resistant article so as to, during the heat treatment to form the wear-resistant article, effectively block diffusion into the substrate of one or more components (i.e., diffusible elements) contained in the hardfacing alloy component of the wear-resistant cladding layer so that the substrate is not sensitized due to the penetration of such diffusible elements, as well as a method of making the wear-resistant article and media, as well as a method making such diffusion barrier layer. The diffusion barrier layer separates the substrate from the wear-resistant cladding layer.

### SUMMARY OF THE INVENTION

In one form thereof, the invention is a wear-resistant article that includes a substrate that presents a surface. The substrate has a bulk region and a surface region that begins at and extends inward from the surface toward the bulk region. There is a diffusion barrier layer on at least a portion of the surface of the substrate wherein the diffusion barrier layer is a nickel-based alloy. A wear-resistant cladding layer is on the diffusion barrier layer. The wear-resistant cladding layer contains boron. The surface region of the substrate contains no boron that has been diffused from the wear-resistant cladding layer.

In another form thereof, the invention is a wear-resistant article that includes a substrate that presents a surface. There is a diffusion barrier layer on at least a portion of the surface of the substrate. The diffusion barrier comprises nickel, chromium and molybdenum. There is a wear-resistant cladding layer is on the diffusion barrier layer. The wear-resistant cladding layer contains at least one diffusible element having an atomic radius less than 1 Angstrom.

In yet another form thereof, the invention is a diffusion barrier layer. The diffusion barrier layer is mediate of and in contact with a substrate and a wear-resistant cladding layer. The wear-resistant cladding layer contains at least one diffusible element that has an atomic radius less than 1 Angstrom. The diffusion barrier layer comprises a nickel-based alloy that is substantially impenetrable at a temperature equal to or less than about 1300° C. for a duration up to 30 minutes to the diffusion of the diffusible element from the wear-resistant cladding layer into the substrate.

In still another form thereof, the invention is a method of making a wear-resistant article comprising the steps of: providing a substrate wherein the substrate having a surface; applying a diffusion barrier layer on at least a portion of the surface of the substrate wherein the diffusion barrier layer has a solidus temperature and a porosity equal to less than about 5 percent; applying a wear-resistant layer on the diffusion barrier layer, the wear-resistant cladding layer containing at least one diffusible element having an atomic radius less than about one Angstrom, and the wear-resistant cladding layer having a solidus temperature; and heating the diffusion barrier layer and the wear-resistant cladding layer to a temperature that is greater than the solidus temperature of the wear-resistant cladding layer and less than the solidus temperature of the diffusion barrier layer so as to bond the wear-resistant cladding layer to the diffusion barrier layer whereby the substrate does not contain any content of the diffusible element due to the diffusion of the diffusible element from the wear-resistant cladding layer.

### BRIEF DESCRIPTION OF THE DRAWINGS

The following is a brief description of the drawings which form a part of this patent application:

FIG. 1 is an isometric view of a single screw extruder that can be used for the extrusion of pet food, animal feed, cereal and other like materials wherein the extruder screw is exploded away from the extruder barrel and wherein a portion of the extruder screw is cut away to show the wear-resistant cladding layer thereon and a portion of the extruder barrel is cut away to show the location of the wear-resistant cladding layer thereon;

FIG. 2 is a cross-sectional schematic view showing the substrate (including the surface region and a portion of the bulk region), and the layers of the wear-resistant article wherein these layers include the diffusion barrier layer on the surface of the substrate and the wear-resistant cladding layer on the diffusion barrier layer;

FIG. 3 is a photomicrograph (scale of 0.003 inches (0.076 millimeters) as shown by black bar at lower right corner) of Comparative Sample No. 1 after being etched with Vilella's reagent that shows the microstructure of the interface at the surface of the substrate showing the substrate including the surface region (in brackets) and the bulk region, the diffusion barrier layer and the region of the wear-resistant cladding layer that is adjacent to the diffusion barrier layer;

FIG. 4 is a photomicrograph (scale of 0.003 inches (0.076 millimeters) as shown by black bar at lower right corner) of Comparative Sample No. 2 after being etched with Vilella's reagent that shows the microstructure of the interface at the surface of the substrate showing the substrate including the surface region (in brackets) and the bulk region, the diffusion barrier layer and the region of the wear-resistant cladding layer that is adjacent to the diffusion barrier layer;

FIG. 5 is a photomicrograph (scale of 0.003 inches (0.076 millimeters) as shown by black bar at lower right corner) of Inventive Sample No. 3 after being etched with Vilella's reagent that shows the microstructure of the interface at the surface of the substrate showing the surface region of the substrate, the bulk region of the substrate, and the diffusion barrier layer;

FIG. 6 is a photomicrograph (scale of 0.003 inches (0.076 millimeters) as shown by black bar at lower right corner) of Comparative Sample No. 4 after being etched with Vilella's reagent that shows the microstructure of the interface at the surface of the substrate showing the substrate including the surface region (in brackets) and the bulk region, the diffusion barrier layer and the region of the wear-resistant cladding layer that is adjacent to the diffusion barrier layer;

FIG. 7 is a photomicrograph (magnification equal to 50×) of Comparative Sample No. 5 after being etched with Vilella's reagent that shows the microstructure of the interface at the surface of the substrate showing the substrate including the surface region (in brackets) and the bulk region, the diffusion barrier layer and the region of the wear-resistant layer that is adjacent to the diffusion barrier layer;

FIG. 8 is a photomicrograph (scale of 0.003 inches (0.076 millimeters) as shown by black bar at lower right corner) of Inventive Sample No. 6 after being etched with Vilella's reagent that shows the microstructure of the interface at the surface of the substrate showing the surface region of the substrate, the bulk region of the substrate and the diffusion barrier layer;

FIG. 9 is a photomicrograph (scale of 0.003 inches (0.076 millimeters) as shown by black bar at lower right corner) of Comparative Sample No. 7 after being etched with Vilella's reagent that shows the microstructure of the interface at the surface of the substrate showing the substrate including the surface region (in brackets) and the bulk region, the diffusion barrier layer and the region of the wear-resistant layer that is adjacent to the diffusion barrier layer; and

FIG. 10 is a photomicrograph (scale of 0.003 inches (0.076 millimeters) as shown by black bar at lower right corner) of Inventive Sample No. 8 after being etched with Vilella's reagent that shows the microstructure of the interface at the surface of the substrate showing the substrate including the surface region (in brackets) and the bulk region, the diffusion barrier layer and the region of the wear-resistant layer that is adjacent to the diffusion barrier layer.

### DETAILED DESCRIPTION OF THE INVENTION

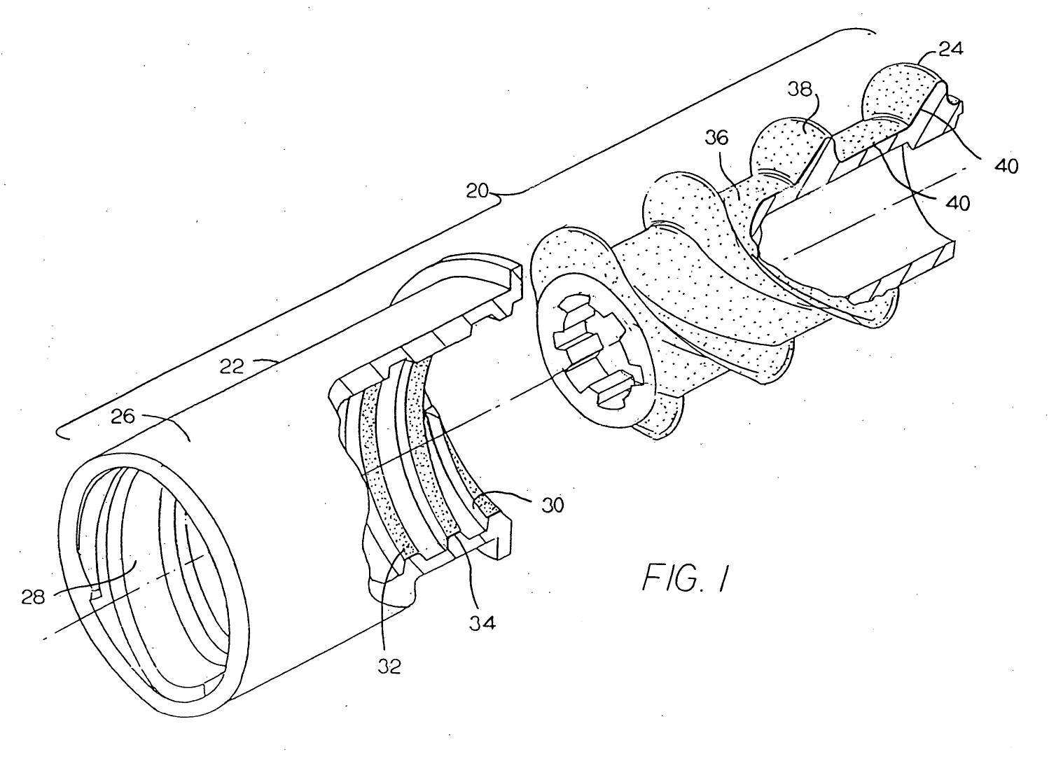

Referring to the drawings, FIG. 1 illustrates a single screw extruder arrangement as shown by brackets 20. The single screw extruder arrangement 20 includes an extruder barrel 22 and an extruder screw 24. The extruder barrel 22 has an exterior surface 26 and an interior surface 28. The interior surface 28 presents a helical rib 30 that travels for the length of the extruder barrel 22. The helical rib 30 has a top surface 32 on which there is a wear-resistant cladding layer 34. The extruder screw 24 has an exterior surface 36 from which there projects a helical flight 38. A wear-resistant layer 40 is on the exterior surface 36 and the helical flight 38 of the extruder screw 24.

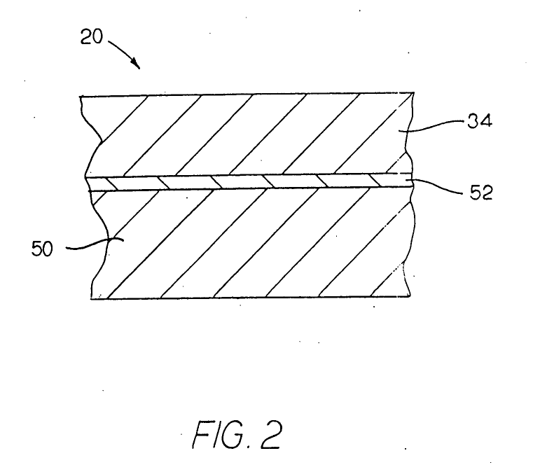

Referring to the regions of each one of the extruder screw 24 that has the wear-resistant layer 40 and the portions of the extruder barrel 22 that has the wear-resistant layer 34 thereon, the schematic cross-sectional view of FIG. 2 shows in schematic form the layers and the substrate. In this regard, FIG. 2 illustrates the substrate 50 on top of which there is a diffusion barrier layer 52. The wear-resistant layer (34 or 40) is on top of the diffusion barrier layer 52. An Application Data Sheet PF-001 entitled “Wear Protection for a Single Screw Extruder” (©02003) available from Conforma Clad, Inc. describes and depicts a single screw extruder.

The diffusion barrier layer 52 can be applied by any one of a variety of techniques. These techniques include furnace brazing, induction brazing, thermal spraying, electroplating and welding. One preferred technique to apply the diffusion barrier layer is furnace brazing.

When first applied to the surface of the substrate, the diffusion barrier layer should have porosity equal to less than about 5 percent. It is preferable that the diffusion barrier layer comprises a nickel-based alloy. It is also preferable that the composition of the diffusion barrier layer includes less than 0.5 atomic percent of elements that have an atomic radius less than one Angstrom, and that the composition of the diffusion barrier layer has a solidus greater than the liquidus of the wear-resistant cladding layer in conjunction with which it is used. One preferred material for use as the diffusion barrier layer comprises a combination of a nickel-based steel alloy (e.g., HASTELLOY® [a registered trademark of Haynes Stellite Company that has a place of business at 1020 West Park Avenue, Kokomo, Ind. 46904] C-276) and a braze alloy that contains, as the predominant components, nickel and silicon and chromium (e.g., NICROBRAZ® (a registered trademark of Wall Colmonoy Corporation that has a place of business at 30261 Stephenson Highway, Madison Heights, Mich. 48071) 30 (i.e., NB-30). A preferred ratio of the HASTELLOY® C-276) to the NICROBRAZ® 30 is 1:1 by weight.

The composition of HASTELLOY® C-276 is (in weight percent): nickel 57%; chromium 16%; iron 5%; silicon 0.08%; manganese 1%; carbon 0.01%; molybdenum 16%; tungsten 4%; cobalt 2.5%; vanadium 0.35%. The composition (in weight percent) for the NICROBRAZ® 30 braze alloy is: chromium 19.0%; silicon 10.2%; carbon 0.06% maximum; and the balance nickel. In a broader context, the diffusion barrier layer has a composition that comprises nickel, chromium, and molybdenum wherein the nickel is the predominant component. The diffusion barrier layer may also contain one or more of the following elements: silicon, tungsten, cobalt, iron, manganese, vanadium and carbon

The wear-resistant cladding layer comprises a matrix of hard particles (e.g., tungsten carbide particles) in a hardfacing alloy (or metallic binder) that includes, as the predominant components, nickel and boron and chromium and cobalt. Exemplary wear-resistant cladding layers are the WC 219 cladding, the WC 200 cladding, and the WC 210 cladding made and sold by Conforma Clad, Inc. The compositions of the WC 200 cladding, the WC 210 cladding and the WC 219 cladding are set forth in the Table 1 herein.

TABLE 1
Composition in Weight Percent of
WC 200 Cladding, WC 210 Cladding and WC 219 Cladding

| | WC 200 (Weight | WC 210 (weight | WC 219 (Weight |
|---|---|---|---|
| Component | Percent) | percent) | Percent) |
| Tungsten | 60.2% | 51.0% | 44.7% |
| carbide | | | |
| Nickel | 30% | 35% | 40% |
| Chromium | 5% | 7% | 8% |
| Boron | 1.5% | 1.5% | 1.5% |
| Cobalt | 3% | 3% | 2% |
| Iron | 0.3% | 1% | 1.3% |
| Molybdenum | — | 1.5% | 2.5% |

Table 2 set forth herein presents the ranges of the components of the wear-resistant cladding layer including the broader preferred range and several narrower preferred ranges of the components.

TABLE 2
Ranges of the Composition (in Weight Percent) of the Wear-Resistant
Cladding Layer

| | Broader | | Another | Still Another |
|---|---|---|---|---|
| | Preferred | One Preferred | Preferred | Preferred |
| Component | Range | Range | Range | Range |
| Tungsten | 40–70% | 40–50% | 50–60% | 60–70% |
| carbide | | | | |
| Nickel | 25–45% | 25–35% | 30–40% | 35–45% |
| Chromium | 4–10% | 4–6% | 6–8% | 7–10% |
| Boron | 0.5–2.5% | 1–2% | 1–2% | 1–2% |
| Cobalt | 1–4% | 2–4% | 2–4% | 1–3% |
| Iron | 0.1–2% | 0.1–0.5% | 0.5–1.5% | 1–2% |
| Molybdenum | Up to 3% | None | 1–2% | 2–3% |

In a broader aspect, the wear-resistant cladding layer comprises hard particles and a hardfacing alloy wherein the hard particles comprise one or more hard particles selected from the group consisting of the following: tungsten carbide, chromium carbide, tantalum carbide, niobium carbide, vanadium carbide, iron carbide, silicon carbide and silicon nitride. The hardfacing alloy is selected from the group consisting of one or more of nickel, cobalt, chromium, iron and their alloys. The wear-resistant cladding layer contains at least one diffusible element having an atomic radius equal to less than 1 Angstrom.

In regard to the method of applying the wear-resistant layer (or cladding), one method comprises placing a flexible cloth that contains the hard particles on the selected surfaces of the article. Another flexible cloth that contains the hardfacing alloy is then positioned to top of the first flexible cloth. The cloths and the article are heated to a suitable temperature so as cause the hardfacing alloy to melt. The result is that the hard particles are metallurgically bonded to the substrate (i.e., the article). Technical Bulletin GN-001 entitled “Standard Tungsten Carbide Cladding Formulas” (©2003) discusses the use of certain cladding materials. This Technical Bulletin is available from Conforma Clad, Inc. Another method used to apply the wear-resistant cladding layer comprises the application of tungsten carbide paint which contains a nickel-chromium-boron braze material.

In one aspect, the wear-resistant cladding layer comprises between about 40 weight percent and about 70 weight percent tungsten carbide, between about 25 weight percent and about 45 weight percent nickel, between about 4 weight percent and about 10 weight percent chromium and between about 0.5 weight percent and about 2.5 weight percent boron. In another aspect, the wear-resistant cladding layer further comprises between about 1 weight percent and about 4 weight percent cobalt, between about 0.1 weight percent and about 2 weight percent iron and up to about 3 weight percent molybdenum.

In another aspect, the wear-resistant cladding layer comprises between about 40 weight percent and about 50 weight percent tungsten carbide, between about 25 weight percent and about 35 weight percent nickel, between about 4 weight percent and about 6 weight percent chromium and between about 1 weight percent and about 2 weight percent boron, between about 2 weight percent and about 4 weight percent cobalt, and between about 0.1 weight percent and about 0.5 weight percent iron.

In yet another aspect, the wear-resistant cladding layer comprises between about 50 weight percent and about 60 weight percent tungsten carbide, between about 30 weight percent and about 40 weight percent nickel, between about 6 weight percent and about 8 weight percent chromium and between about 1 weight percent and about 2 weight percent boron, between about 2 weight percent and about 4 weight percent cobalt, between about 0.1 weight percent and about 0.5 weight percent iron, and between about 1 weight percent and about 2 weight percent molybdenum.

In still another aspect, the wear-resistant cladding layer comprises between about 60 weight percent and about 70 weight percent tungsten carbide, between about 35 weight percent and about 45 weight percent nickel, between about 7 weight percent and about 10 weight percent chromium and between about 1 weight percent and about 2 weight percent boron, between about 1 weight percent and about 3 weight percent cobalt, between about 1 weight percent and about 2 weight percent iron, and between about 2 weight percent and about 3 weight percent molybdenum.

Applicants have conducted comparative testing on the samples that are described in Table 3 herein. In this regard, coupons of the stainless steel substrates identified in Table 3 were treated as described below.

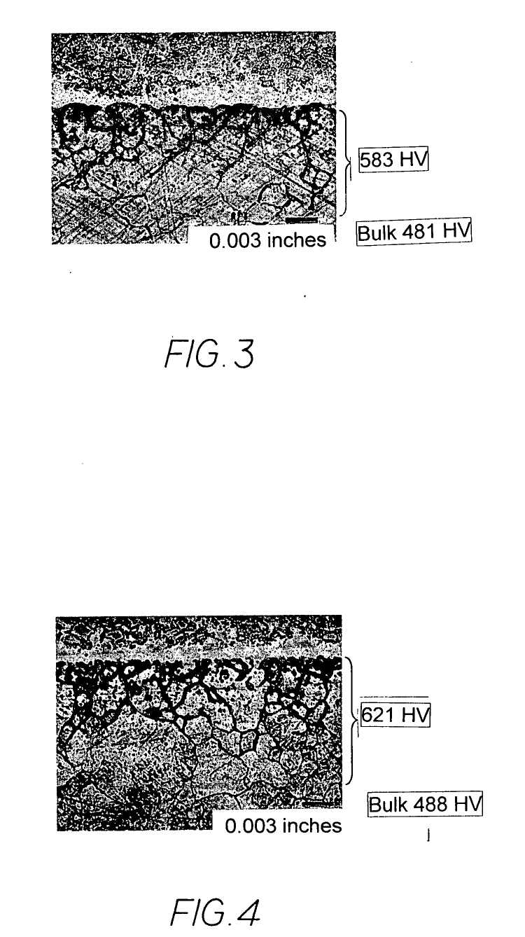

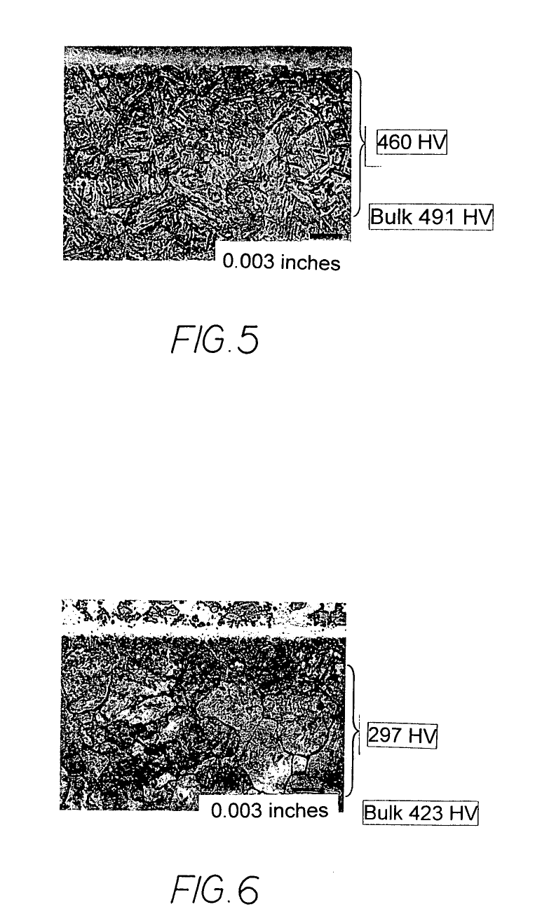

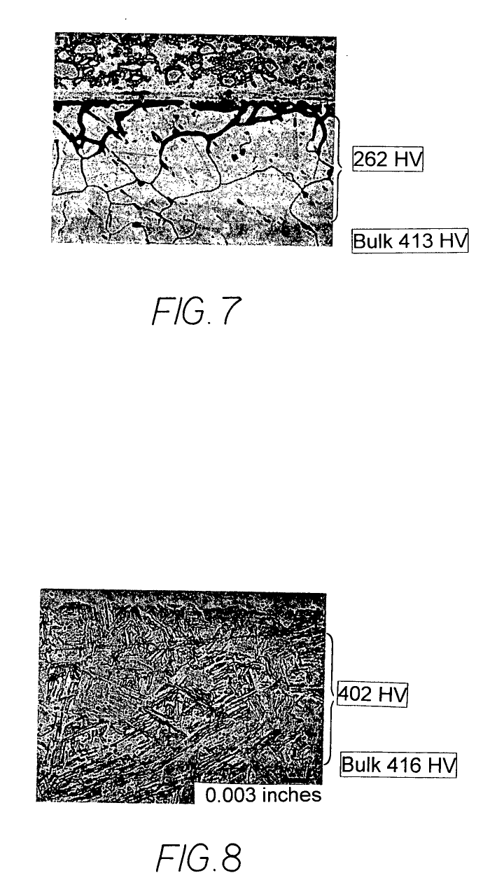

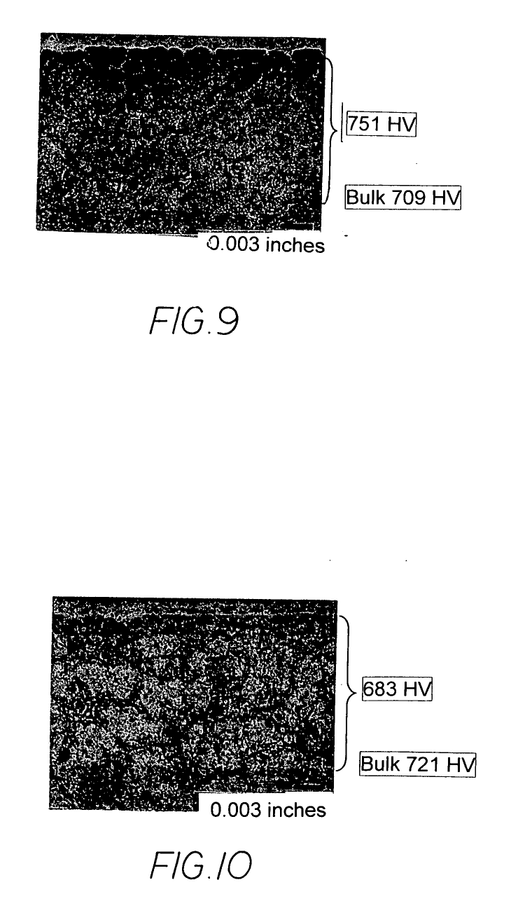

TABLE 3
Description of Comparative and Inventive Samples

| | | | Wear- |
|---|---|---|---|
| | | | Resistant |
| | | | Cladding |
| Sample | Substrate | Mediate Layer | Layer |
| Comparative Sample | CA15 | None | WC 219 |
| 1 [FIG. 3 | | | |
| photomicrograph] | | | |
| Comparative Sample | CA15 | Electrolytic Nickel | WC 219 |
| 2 [FIG. 4 | | | |
| photomicrograph] | | | |
| Inventive Sample 3 | CA15 | HASTELLOY ® C- | WC 219 |
| [FIG. 5 | | 276 alloy steel and | |
| photomicrograph] | | the NB-30 braze | |
| | | alloy in a 1:1 ratio by | |
| | | weight | |
| Comparative Sample | CA6NM | None | WC 219 |
| 4 [FIG. 6 | | | |
| photomicrograph] | | | |
| Comparative Sample | CA6NM | Electrolytic Nickel | WC 219 |
| 5 [FIG. 7 | | | |
| photomicrograph] | | | |
| Inventive Sample 6 | CA6NM | HASTELLOY ® C- | WC 219 |
| [FIG. 8 | | 276 alloy steel and | |
| photomicrograph] | | the NB-30 braze | |
| | | alloy in a 1:1 ratio by | |
| | | weight | |
| Comparative Sample | 440C | None | WC 219 |
| 7 [FIG. 9 | | | |
| photomicrograph] | | | |
| Inventive Sample 8 | 440C | HASTELLOY ® C- | WC 219 |
| [FIG. 10 | | 276 alloy steel and | |
| photomicrograph] | | the NB-30 braze | |
| | | alloy in a 1:1 ratio by | |
| | | weight | |

In Table 3, the substrates were a CA15 stainless steel (ASTM Standard 217/A 217M-91) substrate, a CA6NM stainless steel (ASTM Standard A-89) substrate, and a 440C stainless steel (ASTM Standard A 276-00a) substrate. The compositions of these substrates is set forth in Table 4 herein.

TABLE 4
Compositions (weight percent) of Stainless Steel Substrates used
for the Samples

| Element | CA15 | CA6NM | 440C |
|---|---|---|---|
| Carbon | 0.15 | 0.06 | 0.95–1.20 |
| Silicon | 1.50 | 1.00 | 1.00 |
| Manganese | 1.00 | 1.00 | 1.00 |
| Phosphorus | 0.040 | 0.04 | 0.040 |
| Sulfur | 0.040 | 0.03 | 0.030 |
| Nickel | 1.00 | 3.5–4.5 | None |
| Chromium | 11.5–14.0 | 11.5–14.0 | 16.0–18.0 |
| Molybdenum | 0.50 | 0.4–1.0 | 0.75 |
| Balance Iron | Balance iron | Balance iron | Balance iron |

It should be noted that none of these substrates contained boron as an intentional component. It should be appreciated that the substrate can comprise a stainless steel that contains between about 11 weight percent and about 20 weight percent chromium. It should also be appreciated that the substrate may further contain between about 1 weight percent and about 5 weight percent nickel.

Referring to the treatment of the samples as set forth in Table 3, Comparative Samples 1, 4 and 7 were samples that did not include a mediate layer. For each one of these Comparative Samples 1, 4 and 7, the substrate had the WC 219 cladding applied thereto at a brazing temperature equal to about 2060° F. (1127° C.) in vacuum. More specifically, a flexible cloth containing the WC 219 cladding was placed on the surface of the sample and heated to a temperature equal to about 2060° F. (1127° C.) and held at this temperature (1127° C.) for a duration of 30 minutes. The WC 219 cladding was metallurgically bonded to the surface of the substrate.

Comparative Samples 2 and 5 were samples in which the substrate was first coated with electrolytic nickel. The thickness of the electrolytic nickel coating layer was about 50 micrometers. The substrate with the electrolytic nickel layer thereon was then cladded with the WC 219 cladding at a temperature equal to about 2060° F. (1127° C.) in vacuum. Like for the above samples, a flexible cloth containing the WC 219 cladding was placed on the surface of the electrolytic nickel layer (on the substrate) and heated to a temperature equal to about 2060° F. (1127° C.) and held at this temperature (1127° C.) for a duration of 30 minutes. The WC 219 cladding was metallurgically bonded to the electrolytic nickel layer.

Inventive Samples 3, 6 and 8 were samples in which a diffusion barrier layer was first applied to the surface of the substrate. The diffusion barrier layer, which comprised HASTELLOY® C-276 alloy steel and the NICROBRAZ® 30 (NB 30) braze material, was applied according to the following procedure: a C-276 cloth (i.e., a PTFE cloth with HASTELLOY® C-276 alloy steel particles embedded throughout the cloth) was applied to the surface of the substrate, and then particles of NICROBRAZ® 30 braze material were applied to top of the C-276 cloth in a 1:1 ratio by weight (i.e., a 1:1 ratio by weight of the HASTELLOY® C-276 alloy steel particles to the NICROBRAZ® 30 (NB 30) braze material), and then the HASTELLOY® C-276 cloth-NICROBRAZ® 30 braze composite was brazed at a temperature equal to 2100° F. (1127° C.) in vacuum so as to held at 1127° C. for 30 minutes. Like for the above samples, a flexible cloth containing the WC 219 cladding was placed on the surface of the diffusion barrier layer (on the sample) and heated to a temperature equal to about 2060° F. (1127° C.) and held at this temperature for a duration of 30 minutes. The WC 219 cladding was metallurgically bonded to the diffusion barrier layer.

When the weight ratio of the HASTELLOY® C-276 alloy steel particles to the NICROBRAZ® 30 (NB 30) braze material) is equal to 1:1, Table 5 below sets forth the content by weight of the diffusion barrier layer.

TABLE 5
Content (by Weight Percent) of the Diffusion Barrier Layer When the
Weight Ratio of the HASTELLOY ® C-276 Alloy Steel
Particles to the NICROBRAZ ® 30 (NB 30)
braze material) is Equal to 1:1

| Component | Content in Weight Percent |
|---|---|
| Nickel | 63.87 |
| Chromium | 17.5 |
| Iron | 2.5 |
| Silicon | 5.14 |
| Manganese | 0.5 |
| Carbon | .035 |
| Molybdenum | 8 |
| Tungsten | 2 |
| Cobalt | 1.25 |
| Vanadium | 0.175 |

As disclosed in each of the above examples, the heat treatments used to metallurgically bond the WC219 cladding to the diffusion barrier layer occurred at a temperature equal to about 1127° C. It should be appreciated that the heat treatment temperature can range between about 1054° C. and about 1149° C. More preferably, the heat treatment temperature can range between about 1116° C. and about 1127° C. The duration of this heat treatment can range between about 15 minutes and about 60 minutes. More preferably, the duration of this heat treatment may range between about 15 minutes and about 30 minutes.

Each of the above samples were sectioned and then etched with Vilella's reagent per ASTM Standard E3-01 Standard Practice for Preparation of Metallographic Specimens. Photomicrographs were taken of the etched sectioned samples and microhardness measurements (300 Vickers) per ASTM Standard E384-99e1 Test Method for Microhardness Indentation of Materials were taken of bulk region of the substrate and the surface region of the substrate. The surface region begins at (or near) and extends inwardly from the surface of the substrate a specific distance.

Referring to the photomicrographs, FIG. 3 shows that for Comparative Sample 1, the Vilella's reagent attacked the grain boundaries, which shows that the CA15 stainless steel substrate had been sensitized by the diffusion of boron therein. It is apparent that the most severe attack of the grain boundaries by the Vilella's reagent was at or near the surface of the substrate and diminished toward the bulk region of the substrate. In this regard, it should be noted that the microhardness in the surface region (or diffusion zone) was 583 HV, which is higher than the hardness (i.e., 481 HV) in the bulk region of the substrate.

Applicants believe that the higher microhardness in the diffusion zone is due to the presence of boron therein wherein the boron had diffused directly into the substrate from the WC 219 cladding during the brazing operation (i.e., heat treatment). In this regard, it should be appreciated that the WC219 cladding, which contained the boron, was placed directly on the surface of the CA15 substrate.

FIG. 4 shows that for Comparative Sample 2, the Vilella's reagent also attacked the grain boundaries in the portion of the substrate that was sensitized by the diffusion of boron from the WC 219 cladding. Here, the boron diffused directly through the electrolytic nickel layer deposited on the surface of the CA15 substrate. It is apparent that the most severe attack of the grain boundaries by the Vilella's reagent was at or near the surface of the substrate and diminished toward the bulk region of the substrate.

For Comparative Sample 2, the microhardness in the surface region or diffusion zone was 621 HV as compared to the microhardness of 488 HV in the bulk region. The higher microhardness in the surface region is consistent with the presence of boron in the surface region or diffusion zone. As mentioned earlier, it is undesirable for an element like boron to diffuse into the substrate because it sensitizes the substrate and makes it susceptible to grain boundary corrosion as demonstrated by the fact that the Vilella's reagent attacked the grain boundaries.

In contrast to Comparative Samples 1 and 2, FIG. 5 very clearly shows for Inventive Sample 3, which used a CA15 substrate like Comparative Samples 1 and 2, that the Vilella's reagent did not attack the grain boundaries in the surface region of the substrate. The microhardness in the surface region (i.e., 460 HV) is lower than the microhardness (i.e., 491 HV) in the bulk region of the substrate.

In applicants' belief, the absence of any attack of the grain boundaries by the Vilella's reagent and the comparative microhardnesses between the surface region and the bulk region are indicative of the absence of boron from the surface region of the substrate of Inventive Sample 3. Keeping in mind that the CA15 substrate of Inventive Example 3 did not contain any boron as an intentional element, the differences in the grain boundary attack and the microhardness between Inventive Sample 3 and Comparative Samples 1 and 2 demonstrates the effectiveness of the diffusion barrier layer of Inventive Sample 3 in blocking the diffusion of boron into the substrate. For Inventive Sample 3, the substrate has no boron (i.e., diffusion element) content due to any diffusion of the boron (i.e., diffusible element) from the wear-resistant cladding layer since it is apparent that boron did not diffuse from the wear-resistant cladding into the substrate.

FIG. 6 shows that for Comparative Sample 4, the Vilella's reagent attacked the grain boundaries sensitized by the diffusion of boron into the CA6NM stainless steel substrate from the WC 219 cladding during the brazing (or heat treatment). Here, it should be noted that the WC219 cladding, which contained boron, was placed directly on the surface of the CA6NM substrate. Further, it should be noted that the microhardness in the surface region or diffusion zone was 297 HV, which is lower than the microhardness in the bulk region (i.e., 423 HV).

The difference in the microhardness in the surface region of the substrate and the bulk region of the substrate taken together with the presence of grain boundary attack causes applicants to believe that boron diffused from the WC219 cladding into the substrate during the heat treatment. A comparison between Comparative Samples 1 and 4 reveals that the diffusion of boron created different results with respect to the relative hardness between the surface region and the bulk region. Applicants believe that the difference in the chemistry of the CA15 substrate and the CA6NM substrate most likely was the cause for this difference in relative hardness.

As mentioned earlier, it is undesirable for an element like boron to diffuse into the substrate because it sensitizes the substrate and makes it susceptible to grain boundary corrosion.

FIG. 7 shows that for Comparative Sample 5, the Vilella's reagent also attacked the grain boundaries of the CA6NM substrate that was sensitized by the diffusion of boron from the WC 219 cladding. Here, the boron diffused through the electrolytic nickel layer deposited on the surface of the CA6NM substrate.

Like for Comparative Sample 4, the microhardness of the diffusion zone (i.e., 262 HV) was less than the microhardness of the bulk substrate (413 HV). A comparison between Comparative Samples 2 and 5 reveals that the diffusion of boron created different results with respect to the relative hardness between the surface region and the bulk region. Applicants believe that the difference in the chemistry of the CA15 substrate and the CA6NM substrate most likely was the cause for this difference in relative hardness. As mentioned earlier, it is undesirable for an element like boron to diffuse into the substrate because it sensitizes the substrate and makes it susceptible to grain boundary corrosion.

In contrast to Comparative Samples 4 and 5, FIG. 8 very clearly shows for Inventive Sample 6, which used the same CA6NM substrate as did Comparative Samples 4 and 5, that the Vilella's reagent did not attack the grain boundaries in the surface region of the substrate. The microhardness (i.e., 402 HV) in the surface region is about the same as the microhardness (i.e., 416 HV) in the bulk region of the substrate.

It is applicants' belief that the absence of any attack of the grain boundaries by the Vilella's reagent and the comparative hardness between the surface region and the bulk substrate are indicative of the absence of boron in the surface region of the substrate of Inventive Sample 6. Keeping in mind that the CA6NM substrate of Inventive Sample 6 did not contain any boron, the differences in the grain boundary attack and the microhardness between Inventive Sample 6 and Comparative Samples 4 and 5 demonstrates the effectiveness of the diffusion barrier layer of Inventive Sample 6 in blocking the diffusion of boron into the substrate. Here, the substrate had no boron (i.e., diffusible element) content due to the diffusion of the boron (i.e., diffusible element) from the wear-resistant cladding layer. In other words, for Inventive Sample 6, boron did not diffuse from the wear-resistant cladding into the substrate during the brazing (i.e., heat treatment) operation.

FIG. 9 shows that for Comparative Sample 7, the Vilella's reagent attacked the grain boundaries sensitized by the diffusion of boron into the 440C stainless steel substrate. Here, the WC219 cladding that contained the boron was placed directly on the surface of the substrate. Further, it should be noted that the hardness in the diffusion zone was 751 HV, which is higher than the hardness in the bulk (i.e., 709 HV). In view of the grain boundary attack and the hardness differential between the surface region and the bulk region, applicants believe that boron in the WC219 cladding diffused into the substrate during the brazing or heat treatment.

FIG. 10 shows that for Inventive Sample 8, the Vilella's reagent also attacked the grain boundaries of the 440C substrate that apparently was, at least to some extent, sensitized by the diffusion of boron from the WC 219 cladding during the heat treatment. The microhardness in the diffusion zone was 683 HV as compared to the microhardness in the bulk region, which was 721 HV. A comparison of the microstructures and the microhardness of Comparative Sample 7 and Inventive Sample 8 show that in the case of the 440C substrate, the diffusion barrier layer reduced, but did not completely eliminate, the diffusion of boron from the WC 219 cladding into the substrate during brazing.

Applicants believe that difference in the chemistry between the CA15 and CA6NM substrates and the 440C substrate may have been a reason for the presence of some boron in the surface region of Inventive Sample 8 (which used a 440C substrate) and the absence of any boron in the surface region of Inventive Sample 3 (which used the CA15) and Inventive Sample 6 (which used the CA6NM substrate). In addition, diffusion of an element like boron is dependent upon both time and temperature during the brazing process so that applicants believe that the sample (i.e., Inventive Sample 8) using the 440C substrate may have been held at the brazing temperature for a longer duration than the other samples (i.e., Inventive Samples 3 and 6) or possibly were brazed at a slightly higher brazing temperature than the other samples (i.e., Inventive Samples 3 and 6).

It can thus be appreciated that applicants have invented a new and useful wear-resistant article

The patents and other documents identified herein are hereby incorporated by reference herein. Other embodiments of the invention will be apparent to those skilled in the art from a consideration of the specification or a practice of the invention disclosed herein. It is intended that the specification and samples are illustrative only and are not intended to be limiting on the scope of the invention. The true scope and spirit of the invention is indicated by the following claims.

What is claimed is:

1. A wear-resistant article comprising:
a substrate presenting a surface, the substrate having a bulk region and a surface region beginning at and extending inward from the surface toward the bulk region;
a diffusion barrier layer on at least a portion of the surface of the substrate, the diffusion barrier layer being a nickel-based alloy;
a wear-resistant cladding layer on the diffusion barrier layer, and the wear-resistant layer containing boron; and
the surface region of the substrate containing no boron that has been diffused from the wear-resistant cladding layer.

2. The wear-resistant article according to claim 1 wherein the diffusion barrier layer comprising nickel, chromium and molybdenum wherein the nickel is the predominant component.

3. The wear-resistant article according to claim 2 wherein the diffusion barrier layer further comprising one or more of the following elements: silicon, tungsten, cobalt, iron, manganese, vanadium and carbon.

4. The wear-resistant article according to claim 1 wherein the wear-resistant cladding layer comprising hard particles and a hardfacing alloy wherein the hard particles comprise one or more hard particles selected from the group consisting of tungsten carbide, chromium carbide, tantalum carbide, niobium carbide, vanadium carbide, iron carbide, silicon carbide and silicon nitride, and the hardfacing alloy being selected from the group consisting of one or more of nickel, cobalt, chromium, iron and their alloys.

5. The wear-resistant article according to claim 1 wherein the wear-resistant cladding layer comprising between about 40 weight percent and about 70 weight percent tungsten carbide, between about 25 weight percent and about 45 weight percent nickel, between about 4 weight percent and about 10 weight percent chromium and between about 0.5 weight percent and about 2.5 weight percent boron.

6. The wear-resistant article according to claim 5 wherein the wear-resistant cladding layer further comprising between about 1 weight percent and about 4 weight percent cobalt, between about 0.1 weight percent and about 2 weight percent iron and up to about 3 weight percent molybdenum.

7. The wear-resistant article according to claim 1 wherein the wear-resistant cladding layer comprising between about 40 weight percent and about 50 weight percent tungsten carbide, between about 25 weight percent and about 35 weight percent nickel, between about 4 weight percent and about 6 weight percent chromium and between about 1 weight percent and about 2 weight percent boron, between about 2 weight percent and about 4 weight percent cobalt, and between about 0.1 weight percent and about 0.5 weight percent iron.

8. The wear-resistant article according to claim 1 wherein the wear-resistant cladding layer comprising between about 50 weight percent and about 60 weight percent tungsten carbide, between about 30 weight percent and about 40 weight percent nickel, between about 6 weight percent and about 8 weight percent chromium and between about 1 weight percent and about 2 weight percent boron, between about 2 weight percent and about 4 weight percent cobalt, between about 0.1 weight percent and about 0.5 weight percent iron, and between about 1 weight percent and about 2 weight percent molybdenum.

9. The wear-resistant article according to claim 1 wherein the wear-resistant cladding layer comprising between about 60 weight percent and about 70 weight percent tungsten carbide, between about 35 weight percent and about 45 weight percent nickel, between about 7 weight percent and about 10 weight percent chromium and between about 1 weight percent and about 2 weight percent boron, between about 1 weight percent and about 3 weight percent cobalt, between about 1 weight percent and about 2 weight percent iron, and between about 2 weight percent and about 3 weight percent molybdenum.

10. The wear-resistant article according to claim 1 wherein the substrate comprising a stainless steel containing between about 11 weight percent and about 20 weight percent chromium.

11. The wear-resistant article according to claim 10 wherein the substrate further containing between about 1 weight percent and about 5 weight percent nickel.

12. The wear-resistant article according to claim 1 wherein the diffusion barrier layer has a porosity less than or equal to about 5 percent, and has less than about 0.5 atomic percent of elements that have an atomic radius less than about 1 Angstrom.

13. The wear-resistant article according to claim 1 wherein the diffusion barrier layer has a solidus temperature and wear-resistant layer has a liquidus temperature, and the solidus temperature of the diffusion barrier layer being greater than the liquidus temperature of the wear-resistant cladding layer.

14. A wear-resistant article comprising:
a substrate presenting a surface;
a diffusion barrier layer on at least a portion of the surface of the substrate, and the diffusion barrier layer comprising nickel, molybdenum and chromium; and
a wear-resistant cladding layer on the diffusion barrier layer, and the wear-resistant layer containing at least one diffusible element having an atomic radius less than 1 Angstrom.

15. The wear-resistant article of claim 14 wherein no content of the diffusible element is present in the substrate due to diffusion of the diffusible element from the wear-resistant cladding layer.

16. A diffusion barrier layer mediate of and in contact with a substrate and a wear-resistant cladding layer wherein the wear-resistant cladding layer contains at least one diffusible element having an atomic radius less than 1 Angstrom, and the diffusion barrier layer comprising a nickel-based alloy that is substantially impenetrable at a temperature equal to or less than about 1300° C. for a duration up to 30 minutes to the diffusion of the diffusible element from the wear-resistant layer into the substrate.

17. The diffusion barrier layer of claim 16 wherein the diffusible element comprises boron.

18. A method of making a wear-resistant article comprising the steps of:
providing a substrate wherein the substrate having a surface;
applying a diffusion barrier layer on at least a portion of the surface of the substrate wherein the diffusion barrier layer has a solidus temperature and a porosity equal to less than about 5 percent;
applying a wear-resistant cladding layer on the diffusion barrier layer, the wear-resistant cladding layer containing at least one diffusible element having an atomic radius less than about one Angstrom, and the wear-resistant layer having a solidus temperature; and
heating the diffusion barrier layer and the wear-resistant cladding layer to a temperature that is greater than the solidus temperature of the wear-resistant cladding layer and less than the solidus temperature of the diffusion barrier layer so as to bond the wear-resistant layer to the diffusion barrier layer whereby the substrate does not contain any content of the diffusible element due to the diffusion of the diffusible element from the wear-resistant cladding layer.
